(19) United States
(12) Patent Application Publication
(10) Pub. No.: US 2026/0054239 A1
(43) Pub. Date: Feb. 26, 2026

(54) APPARATUS AND METHOD OF MANUFACTURING DRY ELECTRODE

(71) Applicants: Hyundai Motor Company, Seoul (KR); Kia Corporation, Seoul (KR)

(72) Inventor: Hyun Jin Kim, Hwaseong (KR)

(21) Appl. No.: 18/943,750

(22) Filed: Nov. 11, 2024

(30) Foreign Application Priority Data
Aug. 26, 2024 (KR) 10-2024-0114076

(51) Int. Cl. B01F 35/222; B01F 27/112; H01M 4/04

(52) U.S. Cl. CPC B01F 35/222; B01F 27/112; H01M 4/0435

(57) ABSTRACT

A method of manufacturing a dry electrode includes mixing a dry electrode active material, a conductive material, and a binder through a mixer, wherein mixing the dry electrode active material, the conductive material, and the binder includes controlling a gap between blades configured to be rotatable in the mixer and a chamber wall of the mixer during mixing. The gap is adjusted based on the stage of mixing, with specific gap values for a coating time to complex the conductive material with the active material, a dispersion time to uniformly disperse the binder, and a fibrillization time to form a network between the components. The method may also include an optional chopping time. An apparatus for manufacturing a dry electrode is also disclosed, featuring a mixer with adjustable blades and a chamber for controlling the gap during the mixing process. The apparatus further includes a motor, shaft, and electric cylinders for blade movement, providing precise control over the mixing conditions.

### CROSS-REFERENCE TO RELATED APPLICATION

This application claims under 35 U.S.C. § 119(a) the benefit of Korean Patent Application No. 10-2024-0114076, filed on Aug. 26, 2024, the entire contents of which are incorporated herein by reference.

### BACKGROUND

### Technical Field

The present disclosure relates to manufacture of a dry electrode for batteries.

### Background

Recently, applications of rechargeable secondary batteries are expanding to various fields from small electronic devices to large energy storage systems. Particularly, research and development of secondary batteries is being actively conducted due to rapid growth of the electric vehicle market.

Electrodes of secondary batteries have generally been manufactured through a wet process. In the wet process, a slurry is prepared by dissolving an electrode active material, a binder, and a conductive material included in an electrode in a solvent. However, recently, a dry process that may increase the energy density of a battery compared to the wet process without using the solvent required in the wet process has been receiving much attention.

In the dry process of the electrode, a mixture is prepared by mixing an electrode active material, a conductive material, and a binder without a solvent, and a dry electrode film is formed by performing a film formation process through pressing or calendering. Then manufacture of the electrode may be completed by bonding the formed dry electrode film to a current collector.

Compared to the wet electrode manufacturing process, in the dry electrode manufacturing process, manufacturing time and costs may be reduced because no solvent is used, and a dry electrode film having a high energy density may be obtained because the thickness of the dry electrode film may be controlled.

Since no solvent is used in a dry electrode, a process of mixing dry electrode raw materials plays a very important role in manufacture of a dry electrode film.

### SUMMARY OF THE DISCLOSURE

The present disclosure has been made in an effort to solve the above-described problems associated with the preexisting technologies, and it is an object of the present disclosure to provide an apparatus and method of manufacturing a dry electrode that may overcome a difficulty of using a high shear mixer when mixing a dry electrode mixture.

It is another object of the present disclosure to provide an apparatus and method of manufacturing a dry electrode that may reduce a process time.

It is yet another object of the present disclosure to provide an apparatus and method of manufacturing a dry electrode that include a mixer configured to achieve excellent complexation of an electrode active material and a conductive material and fibrillization of a binder.

The objects of the present disclosure are not limited to the above-mentioned objects, and other objects not mentioned herein will be clearly understood by one having ordinary skill in the art to which the present disclosure pertains from the following description.

In order to achieve the above-described objects of the present disclosure and perform characteristic functions of the present disclosure, which will be described later, features of the present disclosure are as follows.

In one embodiment, the present disclosure provides a method of manufacturing a dry electrode, including mixing a dry electrode active material, a conductive material, and a binder through a mixer, wherein mixing the dry electrode active material, the conductive material, and the binder includes controlling a gap between blades configured to be rotatable in the mixer and a chamber wall of the mixer during mixing.

Controlling the gap may include moving the blades radially inward or outward with respect to the chamber wall. The gap is controlled based on progress of mixing of the dry electrode active material, the conductive material, and the binder.

Mixing the dry electrode active material, the conductive material, and the binder further comprises operating the mixer for a predetermined coating time with a gap of a first value; operating the mixer for a predetermined dispersion time with a gap of a second value; and operating the mixer for a predetermined fibrillization time with a gap of a third value. The second value may be greater than the first value and the third value.

Mixing the dry electrode active material, the conductive material, and the binder may further comprise operating the mixer for a predetermined chopping time with a gap of a fourth value.

The coating time may be a time required for complexation of the conductive material and the dry electrode active material configured such that the conductive material is coated on the dry electrode active material by mixing. The coating time may be determined based on electrical conductivity measured at each predetermined time during mixing of the dry electrode active material, the conductive material, and the binder. The fibrillization time may be a time required for fibrillization of the binder configured such that the binder is fibrillized in the complexed conductive material and dry electrode active material and is determined in advance by a test.

The fibrillization time may be determined based on electrical conductivity measured at each predetermined time during mixing of the binder with the complexed dry electrode active material and conductive material.

The method may further comprise forming a film from a dry electrode mixture where the dry electrode active material, the conductive material, and the binder are mixed.

In another embodiment, the present disclosure provides an apparatus for manufacturing a dry electrode, including a mixer including a housing and blades rotatably disposed in the housing and configured to vary a gap formed with the housing.

The mixer may further comprise drivers configured to move the blades radially inward or outward with respect to the housing. The mixer may further comprise a motor; and a shaft configured to be rotated by the motor, wherein the blades are connected to the shaft.

The apparatus may further comprise electric cylinders mounted on the shaft and configured to move the blades in a radial direction of the shaft.

The apparatus may further comprise a controller configured to control operation of the electric cylinders.

The mixer may further comprise a chamber configured to be rotatable in the housing, and the gap is a distance between a chamber wall and the blades. The mixer may be configured to mix a dry electrode active material, a conductive material, and a binder.

In another embodiment, a method of manufacturing a dry electrode is provided. The method includes mixing a dry electrode active material, a conductive material, and a binder in a mixer, controlling a gap between rotatable blades and a chamber wall of the mixer during mixing, wherein the method further comprises: operating the mixer for a predetermined coating time with a gap of a first value to complex the conductive material with the dry electrode active material, operating the mixer for a predetermined dispersion time with a gap of a second value to uniformly disperse the binder, and operating the mixer for a predetermined fibrillization time with a gap of a third value to fibrillize the binder and form a network between the complexed conductive material and dry electrode active material.

The second value of the gap during the dispersion time may be greater than the first and third values, and the first and third values may be independently selected.

As discussed, the method and system suitably include use of a controller or processer.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 schematically illustrates a process of manufacturing a dry electrode;

FIG. 2 illustrates an exemplary mixer;

FIG. 3 is a cross-sectional view of the mixer, taken along line A1-A1 of FIG. 2, illustrating a process of complexation a dry electrode active material and a conductive material, and fibrillization of a binder in the mixer;

FIG. 4 illustrates a mixer according to one embodiment of the present disclosure;

FIG. 5 is a cross-sectional view taken along line A2-A2 of FIG. 4;

FIGS. 6A, 6B, 6C, and 6D illustrate variable blades of the mixer according to one embodiment of the present disclosure;

FIG. 7 is a flowchart representing control of a gap of the blades of the mixer according to one embodiment of the present disclosure;

FIG. 8A is a graph showing a change in the average conductivity of a predetermined amount of an exemplary dry electrode mixture (a conductive material and a dry electrode active material) over time;

FIG. 8B is a graph showing a change in the average conductivity of the predetermined amount of the exemplary dry electrode mixture over time after addition of a binder; and

FIG. 9 is a graph showing flowabilities of a specific dry electrode mixture before and after chopping.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

In one aspect, the present disclosure relates to manufacture of a dry electrode for batteries, specifically a method and apparatus for producing a dry electrode by mixing a dry electrode active material, a conductive material, and a binder in a mixer with controlled gap adjustments. In aspects, the methods can involve precise control over the gap between rotatable blades and the chamber wall of the mixer, allowing for different gap values during various stages of the mixing process. These stages include a coating phase where the conductive material complexes with the active material, a dispersion phase where the binder is uniformly distributed, and a fibrillization phase where the binder forms a network with the mixed materials. The method may also include an optional chopping phase to adjust the binder properties. This technology can improve the uniformity and quality of the dry electrode, contributing to enhanced battery performance. In further aspects, an apparatus is provided with adjustable blades, a rotatable chamber, and an electric cylinder system for precise control of the gap during the entire process, ensuring in preferred aspects optimal mixing conditions and facilitating the efficient production of high-quality dry electrodes.

Specific structural or functional descriptions set forth in embodiments of the present disclosure will be merely exemplarily given to describe the embodiments depending on the concept of the present disclosure, and the embodiments depending on the concept of the present disclosure may be embodied in different forms. Further, it will be understood that the present disclosure should not be construed as being limited to the embodiments set forth herein, and the embodiments of the present disclosure are provided only to completely disclose the disclosure and cover modifications, equivalents or alternatives which come within the scope and technical range of the disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the drawings to refer to the same or like parts. The terminology used herein is for the purpose of describing particular embodiments only and is not intended to be limiting. As used herein, singular forms may be intended to include plural forms as well, unless the context clearly indicates otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present disclosure will be described in detail with reference to the accompanying drawings.

A dry electrode may be manufactured from a dry electrode mixture M and a current collector without a solvent. The dry electrode mixture M may be a mixture including an electrode active material, a conductive material (or a conductive additive or a conducting agent), and a binder. In addition, the dry electrode mixture M may further include an additive.

The dry electrode may be a cathode or an anode. In some embodiments, when a cathode is manufactured, the electrode active material may include a cathode active material. As a non-limiting example, the cathode active material may include LCO(LiCoO₂), NCM(Li(Ni,Co,Mn)O₂), NCA(Li(Ni,Co,Al)O₂, LMO(LiMnO₄), LFP(LiFePO₄) or sulfur.

In some embodiments, when an anode is manufactured, the electrode active material may include an anode active material. For example, the anode active material may include natural graphite, artificial graphite, mesocarbon microbeads (MCMB), or a silicon-based active material.

The conductive material may include a carbon-based conductive material. For example, the conductive material may include carbon black, acetylene black, carbon fiber, or carbon nanotube.

The binder may include polyvinylidene fluoride (PVDF), polytetrafluoroethylene (PTFE), or a copolymer including the same.

As the additive, a solid polymer electrolyte, such as poly(ethylene oxide) (PEO), or an oxide-based or sulfide-based solid electrolyte component may be used.

The dry electrode material may include 70 to 99.9 weight (wt) % % of the electrode active material, 0.1 wt % to 20 wt % of the conductive material, and 0.1 wt % to 20 wt % of the binder. Here, the additive may be added at a ratio of 0 to 20 wt %.

As shown in FIG. 1, the dry electrode mixture M is manufactured into a dry electrode film F through a series of film formation processes in which heat and pressure are applied. First, the dry electrode mixture M including the electrode active material, the conductive material, and the binder is mixed through a mixer 10 at a predetermined rate for a predetermined time. As a non-limiting example, the dry electrode mixture M may be manufactured through a high shear mixer using rotation, a fluid mixer using air, or the like. The predetermined time and rate may be adjusted through changes in the rotational speed and operating time of the mixer 10.

The dry electrode mixture M mixed in the mixer 10 may be formed into the dry electrode film F by a film formation apparatus. Specifically, the dry electrode mixture M mixed in the mixer 10 may be directed to a feeder 12 or a roll press 20. The dry electrode mixture M may be primarily pressed into the dry electrode film F by the upstream roll press 20. The upstream roll press 20 rotates while providing pressing force to form the dry electrode mixture M into the dry electrode film F. The dry electrode film F that has been primarily formed from the dry electrode mixture M may be additionally pressed by a downstream roll press 30, and the thickness of the dry electrode film F may be adjusted through pressing. Thereafter, the dry electrode film F is wound by a winder 40. Then the dry electrode film F may be bonded or laminated to the current collector, thereby manufacturing a dry electrode.

Herein, the dry electrode mixture M means a powder in which the electrode active material, the conductive material, and the binder are appropriately mixed and dispersed through the mixer 10, and which is in a state of being formable into a film when pressed by the film formation apparatus, i.e., the roll press 20. In the present disclosure, a mixture in which the electrode active material, the conductive material, and the binder simply exist together is referred to as a dry electrode raw material M1 in order to distinguish this mixture from the dry electrode mixture M.

The dry electrode mixture M may be considered as being appropriately mixed and dispersed through fibrillization of the binder and complexation of the electrode active material and the conductive material. In other words, in order to manufacture a dry electrode in the form of a freestanding film, the complexation of the electrode active material and the conductive material plays an important role along with the fibrillization of the binder. The complexation of the electrode active material and the conductive material may be explained as coating of the conductive material on the surface of the electrode active material. The coating of the electrode active material by the conductive material may be achieved by a high shear force applied by the mixer 10. The fibrillization of the binder may be explained as the binder being stretched thinly and long by the high shear force from the mixer 10 to connect the complexed electrode active material and conductive material through a network. The fibrillization of the binder may particularly allow the binder to serve as a structure so that the manufactured dry electrode may become a freestanding film.

The complexation of the electrode active material and the conductive material may cause the conductive material to be uniformly dispersed and coated on the surface of the electrode active material to form electron transfer channels between electrode active material particles and improve electron mobility. Further, the complexation may also affect the characteristics of collision energy between particles during the fibrillization of the binder.

In the manufacturing process of the dry electrode, the fibrillization of the binder and the complexation of the electrode active material and the conductive material may be performed in the mixing process by the mixer 10. In other words, the conductive material is complexed with the electrode active material by mixing the electrode active material and the conductive material, and the network may be formed in the dry electrode mixture by fibrillizing the binder by adding the binder to the complexed particles.

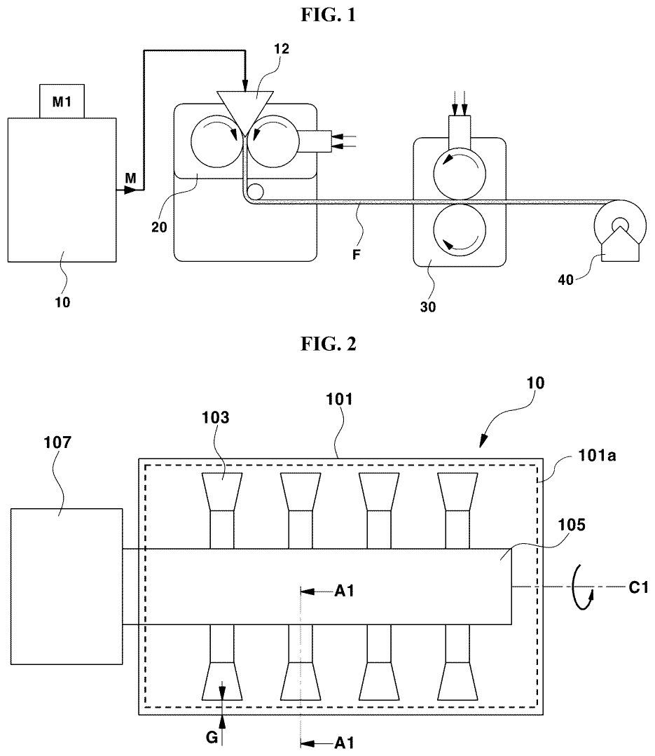

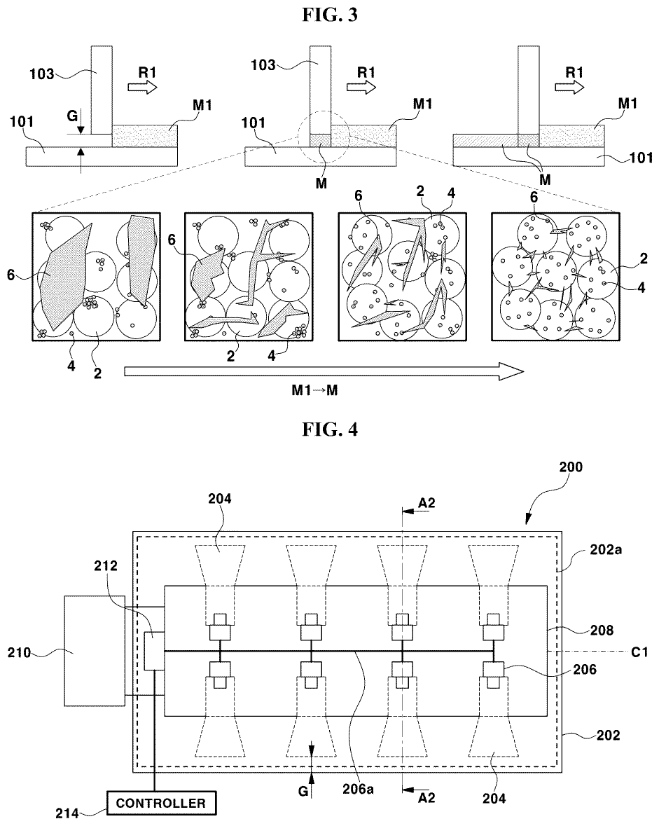

Referring to FIG. 2, the mixer 10 includes a housing 101 and one or more blades 103. The blades 103 may be rotatably disposed in the housing 101. For example, the blades 103 may be mounted on a shaft 105 that is rotated about an axis C1, and the shaft 105 is configured to be rotated by a motor 107. A chamber 101a within the housing 101 may be rotatable. Therefore, both the chamber 101a and the blades 103 may rotate.

The mixer 10 may be a high shear mixer 10. The high shear mixer 10 may apply shear force to a gap G between the blades 103 and the chamber 101a or the housing 101. This may be particularly advantageous in the complexation of the electrode active material and the conductive material and the fibrillization of the binder. For example, a large force may be applied to the dry electrode raw material M1 in the gap G, and the mixing time may be shortened because there are many points where this large force is applied.

As shown in FIG. 3, the high shear mixer 10 may apply the shear force to the dry electrode raw material M1 fed into the mixer 10 to manufacture the dry electrode raw material M1 located in the gap G into the dry electrode material M. This manufacturing process may be explained as mechanofusion which induces interparticle bonding by high compression and shear force. Specifically, as the blades 103 rotate in a direction R1, the dry electrode raw material M1 is gathered into narrow spaces and compressed by the blades 103. Then a high shear force is applied to the dry electrode raw material M1 introduced into the gap G so that the dry electrode raw material M1 may be made into the dry electrode material M in which the complexation of the electrode active material 2 and the conductive material 4 and the fibrillization of the binder 6 is completed. In other words, through this process, as indicated by an arrow (M1→M), as the conductive material is coated on the surface of the electrode active material 2 of the dry electrode raw material M1 and the binder 6 is pulverized and fibrillized, the dry electrode raw material M1 may be made into the dry electrode material M.

However, in a location where a large amount of the binder 6 is distributed in the chamber 101a, the binder 6 may not be pulverized as it passes through the gap G and may act as a strong resistance. In this case, the load factor of the motor 107 may increase, thereby being capable of making it difficult to operate the mixer 10. At this time, since the clumped particles of the dry electrode raw material M1 in the mixer 10 have already filled the gap G, it is impossible to reoperate the mixer 10 even at a low speed after the shutdown of the mixer 10, and the dry electrode raw material M1 in the mixer 10 should be discarded.

As one solution to this, the input amount of the dry electrode raw material M should be reduced to less than the capacity of the mixer 10. This may reduce mass productivity. As another solution, the blades 103 should be rotated at a low speed to sufficiently disperse the binder 6, and the dry electrode raw material M should be mixed while increasing the rotational speed (i.e., RPM) of the blades 103 stepwise. This solution may require a very long process time.

Accordingly, the present disclosure aims to provide a mixer that may effectively produce the dry electrode mixture M by changing the gap G depending on mixing conditions or the progress of mixing, and a dry electrode manufacturing technology including the same.

As shown in FIG. 4, a mixer 200 according to one embodiment of the present disclosure includes a housing 202 and one or more blades 204. The blades 204 are disposed in the housing 202 and are configured to be rotatable. The blades 204 may be mounted on a shaft 208 that is rotated about an axis C1. The shaft 208 may be rotated about the axis C1 by a motor 210.

The housing 202 may include a chamber 202a that is rotatable within the housing 202. The chamber 202a may rotate together with the blades 204. For example, the chamber 202a is configured to rotate in the opposite direction to the blades 204. The blades 204 apply required energy to materials within the mixer 200 through rotation thereof, and the applied energy may enable complexation of particles of the materials, fibrillization of a binder 6, and the like.

The mixer 200 may be a high shear mixer 200, as described above. The high shear mixer 200 may apply shear force to the gap G between the blades 204 and the chamber 202a. This mixer 200 may be particularly advantageous in complexation of an electrode active material 2 and a conductive material 4 and the fibrillization of the binder 6. For example, a large force may be applied to a dry electrode raw material M1 in the gap G, and the mixing time may be shortened because there are many points where this large force is applied.

The mixer 200 may apply the shear force to the dry electrode raw material M1 to manufacture the dry electrode raw material M1 located in the gap G into a dry electrode mixture M. Specifically, the dry electrode raw material M1 put into the mixer 200 may be made into the dry electrode material M in which the complexation of the electrode active material 2 and the conductive material 4 and the fibrillization of the binder 6 have been completed, through the above-described process shown in FIG. 3.

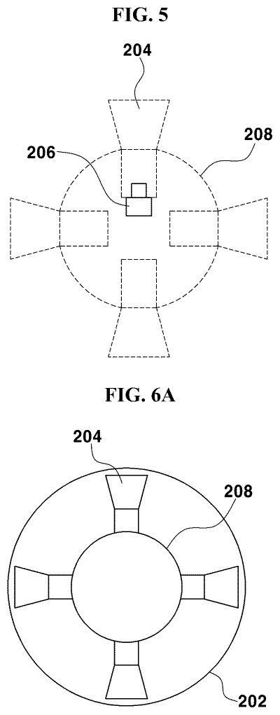

The size of the gap G may be adjusted during the mixing process. In one embodiment, the blades 204 are configured such that the positions of the blades 204 with respect to the chamber 202a or the outer diameter of the blades 204 is variable. For this purpose, the blades 204 may move in the radial direction of the shaft 208. Additionally referring to FIG. 5, the blades 204 may be moved by drivers, such as electric cylinders 206 for moving the blades 204. In one example, the electric cylinders 206 may be mounted on the shaft 208, and the blades 204 may be connected to the electric cylinders 206. A control line 206a for the electric cylinders 206 may extend to the outside through the shaft 208.

The mixer 200 may further include a slip ring 212. The slip ring 212 may transmit a signal without twisting the control line 206a by a fixed portion and a rotation portion of the mixer 200. The slip ring may be a contact type or a non-contact type.

The mixer 200 may further include a controller 214. The controller 214 may control operation of the electric cylinders 206. Specifically, the controller 214 is configured to operate the electric cylinders 206 under predetermined conditions to adjust the diameter of the blades 204 or the gap G. The controller 214 may be a controller configured to control operation of the mixer 200 or may be a separate controller that participates only in operation of the electric cylinders 206.

The controller 214 is configured to adjust the gap G for each predetermined step of the mixing process. The mixing process to produce the dry electrode mixture M from the dry electrode raw material M1 may include a coating step, a dispersion step, and a fibrillization step. The coating step is a complexation step in which the conductive material is coated on the electrode active material during mixing through the mixer 200 to be complexed with the electrode active material. In the dispersion step, the binder 6 is dispersed. In the dispersion step, clumped particles of the binder 6 may be uniformly dispersed throughout. In the fibrillization step, the binder 6 is fibrillized. Through the fibrillization of the binder 6, a network may be formed between the complexed electrode active material 2 and conductive material 4 and the binder 6. In some embodiments, the mixing process may further include a chopping step. The chopping step may selectively be performed as a step of thinning or cutting the length of the binder 6 fibrillized in the fibrillization step.

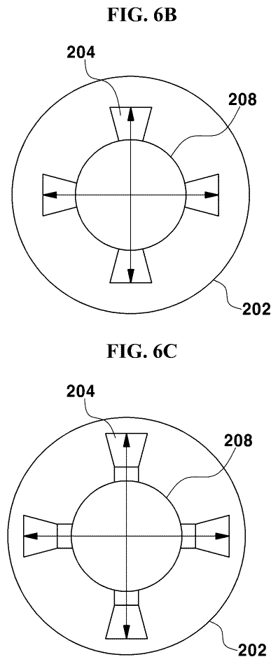

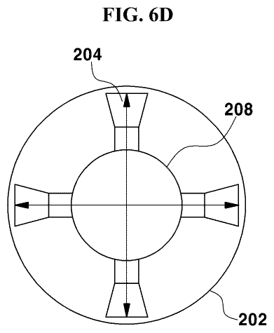

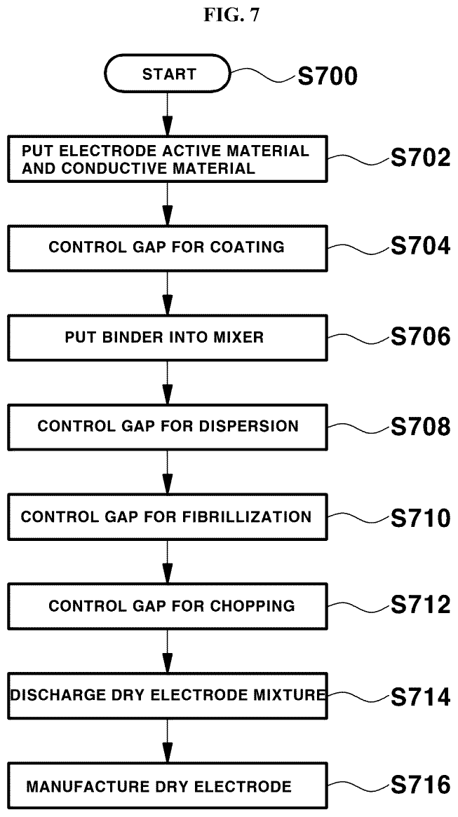

Referring to FIGS. 6A to 6D, in each step of the mixing process, the gap G may be controlled by the controller 214 to have a value in a different range or a different value, or to have a value in the same range or the same value. For example, the gap G may be set to a value within a first range in the coating step, the gap G may be set to a value within a second range in the dispersion step, and the gap G may be set to a value within a third range in the fibrillization step. Here, the first range, the second range, and the third range may be the same as each other or different from each other. In one example, some of the first range, the second range, and the third range may be the same, and some may be different. In some embodiments, the gap G may be set to a value within a fourth range in the chopping step, and the fourth range may be the same as or different from the first range, the second range, and the third range.

In one embodiment, operation of the mixer 200 may be controlled based on the flowchart shown in FIG. 7.

Referring to FIG. 7, the mixing process by the mixer 200 begins at Operation S700. In one embodiment, the mixing speed of the mixer 200 may be maintained the same in each step of the mixing process.

First, the electrode active material 2 and the conductive material 4 are put into the mixer 200 at Operation S702.

Thereafter, the gap G is controlled so that the coating step for the complexation of the electrode active material 2 and the conductive material 4 is performed at Operation S704 (see FIG. 6A). The controller 214 may operate the electric cylinders 206 so that the gap G has a value within the first range. In one test example, the first range may be 2 to 12 millimeter (mm).

Each of the coating step and the fibrillization step of the mixing process may be executed for a predetermined time. The predetermined time may be determined through a mixing process performed in advance before mixing through the mixer 200. For example, the predetermined time may be determined based on the average electrical conductivity of the dry electrode mixture M. This content is disclosed in Korean Patent Application No. 10-2023-0055862, filed by the applicant of the present disclosure.

Briefly, during mixing through the mixer 200, a predetermined amount of the dry electrode mixture M is sampled at regular intervals, e.g., every 1 minute, 5 minutes, 10 minutes, or the like), to measure the electrical conductivity of the dry electrode mixture M. At each interval, the electrical conductivity is measured while applying a constant load (e.g., force or pressure) to the dry electrode mixture M, and the electrical conductivity is measured under each load while increasing the magnitude of the load (e.g., increasing the magnitude of the load by an increment) (for example, the electrical conductivity may be measured under each force while sequentially applying a force of 1 (kilonewton) kN, 2 kN, 3 kN, etc., and in this case, 20 force values from 1 kN to 20 kN may be applied). For example, the electrical conductivity may be measured by an electrical conductivity measurement device, such as a 4-point probe, and pressure may be uniformly applied to the dry electrode mixture M by a pressing device located above the dry electrode mixture M. The average value of the electrical conductivity measured under each load in each period is used as the average electrical conductivity in each period.

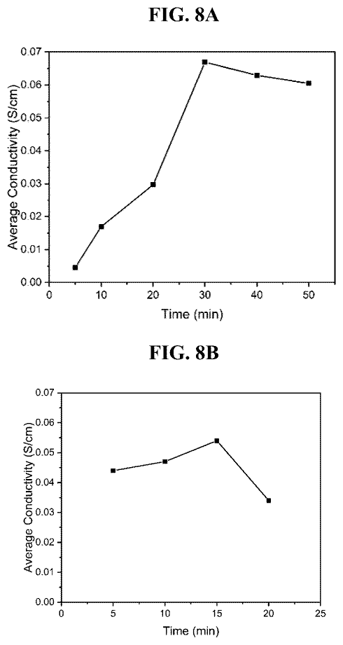

FIG. 8A is a graph showing a change in the average conductivity of a predetermined amount of the dry electrode mixture over time. In FIG. 8A, the first period is 5 minutes, the second period is 10 minutes, the third period is 20 minutes, the fourth period is 30 minutes, the fifth period is 40 minutes, and the sixth period is 50 minutes, and each point in the graph represents the average electrical conductivity in the corresponding period. As shown, as the coating step progresses (i.e., as time elapses), the average electrical conductivity increases as the dispersibility of the conductive material improves. However, after a certain period (30 minutes in the illustrated example), the electrical conductivity decreases. This decrease may be explained as a decrease in electrical conduction channels due to the structural deterioration of the electrode active material or the conductive material. Therefore, the period when the average electrical conductivity value is the largest may be determined as the execution time of the coating step of the mixing process.

Similarly, in the fibrillization step, the average electrical conductivity may be obtained in each period. As shown in FIG. 8B, after the binder is added to the mixing process, while mixing is performed, the predetermined amount of the dry electrode mixture M is sampled at regular intervals (in the illustrated example, 5 minutes, 10 minutes, 15 minutes, and 20 minutes) to measure the electrical conductivity of the dry electrode mixture M. In the fibrillization step, gap control for fibrillization may also be performed during the time representing a period (in the illustrated example, 15 minutes) when the average electrical conductivity is the highest.

The execution times of the coating step and the fibrillization step may be determined by measuring the average electrical conductivity. In the coating step, as the mixing progresses, the dispersibility of the conductive material 4 improves and thus the electrical conductivity of the dry electrode mixture M increases, but after a certain section, particles of the conductive material 4 are inserted between particles of the electrode active material 2, the conduction channels are reduced, and thus the electrical conductivity of the dry electrode mixture M decreases. Therefore, the most desirable complexation state may be obtained using the time at which the average electrical conductivity is the highest. As such, when the time determined by measurement of the average electrical conductivity has elapsed, the coating step may be determined to be completed. This method may also be applied to the fibrillization step.

Thereafter, after the coating step is executed for the predetermined time with the gap within the first range at Operation S704, the binder 6 is put into the mixer 200 at Operation S706.

After the binder 6 is put into the mixer 200, gap control for the dispersion step is performed at Operation S708 (see FIG. 6B). In the dispersion step, the binder 6 may be uniformly dispersed or distributed within the mixer 200. The controller 214 may operate the electric cylinders 206 so that the gap G has a value within the second range. In one test example, the second range may be 16 to 60 mm. The reason why the gap G within the second range in the dispersion step is larger than the gap G within the first range in the coating step is to prevent the motor 210 from being loaded by the binder 6. The gap G in the coating step may be smaller than the gap G in the dispersion step so that the complexation of the electrode active material 2 and the conductive material 4 is performed by a high shear force, and the gap G in the dispersion step is greater than the gap G in the coating step so that the binder 6 is evenly dispersed.

In one embodiment, the dispersion step may be executed several times by adjusting the gap G. For example, the mixer 200 may be operated with a gap G of 20 mm, and then the mixer 200 may be additionally operated with a gap G of 16 mm.

When the dispersion step has been completed, gap control for the fibrillization step is performed at Operation S710 (see FIG. 6C). In the fibrillization step, the binder 6 may be fibrillized. The controller 214 may operate the electric cylinders 206 so that the gap G has a value within the third range. In one test example, the third range may be 2 to 12 mm. In the fibrillization step, a smaller gap G than in the dispersion step is used. In the fibrillization step, similar to the coating step, the gap G may be smaller than the gap G in the dispersion step so that the fibrillization of the binder 6 is achieved by a high shear force by the mixer 200.

According to the present disclosure, even if the load factor of the motor 210 increases during the fibrillization step at Operation S708 and the operation of the motor 210 is stopped, the gap G may be increased, and therefore, the dispersion step may be executed again without discarding the dry electrode raw material M1.

After the fibrillization step is completed, gap control for chopping may be selectively performed at Operation S712 (see FIG. 6D). The chopping step may be executed as needed to control fine fibrillization depending on the purpose of a subsequent process. In the chopping step, a gap G smaller than the gap G in the fibrillization step may be used to thin the binder 6 fibrillized in the fibrillization step or to cut the binder 6 into shorter lengths. Therefore, a gap G of a value smaller than the value within the third range may be used. The controller 214 may operate the electric cylinders 206 so that the gap G has a value within the fourth range.

The chopping step may be selectively executed. In one example, the chopping step may be selectively executed mainly due to the relationship with a pre-built dry electrode manufacturing facility. The dry electrode mixture M may be generally vacuum-transported through pipes. If a designated pipe is clogged with the dry electrode mixture M, the chopping step may be selectively performed to improve flowability of the dry electrode mixture M.

In one example, the execution time of the chopping step may be determined based on the length of the binder 6 of the dry electrode mixture M through an electron microscope, or the like. Before and after the chopping step, images of the dry electrode mixture M are acquired through the electron microscope, and the acquired images are compared to determine a desired execution time of the chopping step depending on the degree of reduction in the length of the binder 6.

In another example, the execution time of the chopping step may be determined by measuring the flowability of the dry electrode mixture M. Measurement of the flowability of the dry electrode mixture M is disclosed in Korean Patent Application No. 10-2023-0021097, filed by the applicant of the present disclosure. Briefly, the flowability of the dry electrode mixture M may be evaluated based on ASTM D6128 of the American Society for Testing and Materials. Shear stresses within a designated range are applied to a certain amount of the dry electrode mixture M (for example, through a mixer), and internal force is measured at the equilibrium state of each shear stress. At a certain point in time after the shear stress has been applied, powder collapse occurs within the dry electrode mixture M, and stress at this time may be measured as the internal force. The measured internal force may be fitted to each applied shear stress, and a differential value at each shear stress may be defined as a flow index.

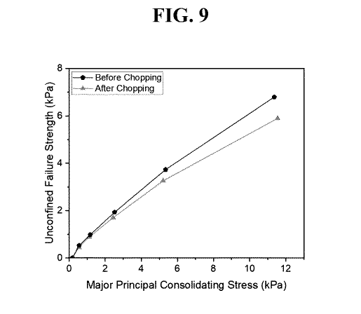

FIG. 9 is a graph showing flowabilities of the dry electrode mixture before and after chopping. As shown in FIG. 9, when the length of the binder is shortened through the chopping step, a difference occurs in the flowability graph. Such a difference is due to the fact that the amount of the electrode material with which one binder particle interfere is reduced as the length of the binder is shortened. Therefore, the desired execution time of the chopping step may be determined by comparing the slopes of curves of the flowability graph.

In some embodiments, whether the chopping step executed for the desired execution time has been completed may be evaluated. For the dry electrode mixture M in which the chopping step has been executed for the desired execution time, it may be evaluated whether the dry electrode mixture M in a desired state is obtained based on the Standard Test Method for Bulk Solids Characterization by Carr Indices (ASTM S5393) of the American Society for Testing and Materials. Depending on this standard test method, the angle of repose (°), angle of fall (°), angle of spatula (°), loose bulk density (g/cm³), packed bulk density (g/cm³), compressibility (%), dispersibility (%), etc., of the corresponding dry electrode mixture M may be measured. Based on the measured values, it may also be determined whether the dry electrode mixture M in the desired state is obtained through the chopping step.

When each step of the mixing process is completed, the dry electrode mixture M is discharged from the mixer 200 at Operation S714. The discharged dry electrode mixture M is a well-complexed and fibrillized mixture and may be transported to the press 20 to be manufactured into a dry electrode. Furthermore, the manufactured dry electrode may be fabricated into a battery.

According to the present disclosure, dry electrode manufacturing technology that may overcome a difficulty of using a high shear mixer when mixing a dry electrode mixture is provided.

According to the present disclosure, dry electrode manufacturing technology that may reduce a process time may be provided.

According to the present disclosure, dry electrode manufacturing technology that includes a mixer configured to achieve excellent complexation of an electrode active material and a conductive material and fibrillization of a binder may be provided.

As is apparent from the above description, the present disclosure provides an apparatus and method of manufacturing a dry electrode that may overcome a difficulty of using a high shear mixer when mixing a dry electrode mixture. The present disclosure provides an apparatus and method of manufacturing a dry electrode that may reduce a process time.

The present disclosure provides an apparatus and method of manufacturing a dry electrode that include a mixer configured to achieve excellent complexation of an electrode active material and a conductive material and fibrillization of a binder.

The effects of the present disclosure are not limited to the above-mentioned effects, and other effects not mentioned herein will be clearly understood by those skilled in the art from the above description.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A method of manufacturing a dry electrode, comprising:
mixing a dry electrode active material, a conductive material, and a binder through a mixer,
wherein the mixing comprises controlling a gap between blades configured to be rotatable in the mixer and a chamber wall of the mixer during mixing.

2. The method of claim 1, wherein controlling the gap comprises moving the blades radially inward or outward with respect to the chamber wall.

3. The method of claim 1, wherein the gap is controlled based on progress of mixing of the dry electrode active material, the conductive material, and the binder.

4. The method of claim 1, wherein mixing the dry electrode active material, the conductive material, and the binder further comprises:
operating the mixer for a predetermined coating time with a gap of a first value;
operating the mixer for a predetermined dispersion time with a gap of a second value; and
operating the mixer for a predetermined fibrillization time with a gap of a third value.

5. The method of claim 4, wherein the second value is greater than the first value and the third value.

6. The method of claim 5, wherein mixing the dry electrode active material, the conductive material, and the binder further comprises operating the mixer for a predetermined
chopping time with a gap of a fourth value.

7. The method of claim 4, wherein the coating time is a time required for complexation of the conductive material and the dry electrode active material configured such that the conductive material is coated on the dry electrode active material by mixing.

8. The method of claim 7, wherein the coating time is determined based on electrical conductivity measured at each predetermined time during mixing of the dry electrode active material, the conductive material, and the binder.

9. The method of claim 7, wherein the fibrillization time is a time required for fibrillization of the binder configured such that the binder is fibrillized in the complexed conductive material and dry electrode active material and is determined in advance by a test.

10. The method of claim 9, wherein the fibrillization time is determined based on electrical conductivity measured at each predetermined time during mixing of the binder with the complexed dry electrode active material and conductive material.

11. The method of claim 1, further comprising forming a film from a dry electrode mixture where the dry electrode active material, the conductive material, and the binder are mixed.

12. An apparatus for manufacturing a dry electrode, comprising a mixer comprising:
a housing; and
one or more blades rotatably disposed in the housing and configured to vary a gap formed with the housing.

13. The apparatus of claim 12, wherein the mixer further comprises drivers configured to move the blades radially inward or outward with respect to the housing.

14. The apparatus of claim 12, wherein the mixer further comprises:
a motor; and
a shaft configured to be rotated by the motor,
wherein the blades are connected to the shaft.

15. The apparatus of claim 14, further comprising electric cylinders mounted on the shaft and configured to move the blades in a radial direction of the shaft.

16. The apparatus of claim 15, further comprising a controller configured to control operation of the electric cylinders.

17. The apparatus of claim 12, wherein the mixer further comprises a chamber configured to be rotatable in the housing, and the gap is a distance between a chamber wall and the blades.

18. The apparatus of claim 12, wherein the mixer is configured to mix a dry electrode active material, a conductive material, and a binder.

19. A method of manufacturing a dry electrode, the method comprising:
mixing a dry electrode active material, a conductive material, and a binder in a mixer,
controlling a gap between rotatable blades and a chamber wall of the mixer during mixing,
wherein the method further comprises:
operating the mixer for a predetermined coating time with a gap of a first value to complex the conductive material with the dry electrode active material,
operating the mixer for a predetermined dispersion time with a gap of a second value to uniformly disperse the binder, and
operating the mixer for a predetermined fibrillization time with a gap of a third value to fibrillize the binder and form a network between the complexed conductive material and dry electrode active material.

20. The method of claim 19, wherein the second value of the gap during the dispersion time is greater than the first and third values, and the first and third values are independently selected.
